(19) United States
(12) Patent Application Publication
(10) Pub. No.: US 2007/0241566 A1
(43) Pub. Date: Oct. 18, 2007

(54) Submersible turbine apparatus

(76) Inventor: Manfred R. Kuehnle, Lincoln, MA (US)

Correspondence Address: HAMILTON, BROOK, SMITH & REYNOLDS, P.C., 530 VIRGINIA ROAD, P.O. BOX 9133, CONCORD, MA, 01742-9133, US

(21) Appl. No.: 11/709,308

(22) Filed: Feb. 21, 2007

Related U.S. Application Data
(60) Provisional application No. 60/778,136, filed on Feb. 28, 2006.
(60) Provisional application No. 60/801,014, filed on May 17, 2006.
(60) Provisional application No. 60/810,390, filed on Jun. 2, 2006.

(51) Int. Cl. F03B 13/26

(52) U.S. Cl. 290/53

(57) ABSTRACT

A submersible turbine apparatus including first and second buoyant turbine units that are connected to each other side by side, and laterally apart from each other. Each turbine unit can include turbine blades that are rotatably mounted about an elongate stationary axle. A lower elongate sealed chamber can be centrally connected to the first and second turbine units below the stationary axles in a manner to provide a center of gravity centrally positioned below the laterally spaced buoyant first and second turbine units to stabilize the turbine apparatus when submersed.

### RELATED APPLICATIONS

This application claims the benefit of U.S. Provisional Application No. 60/778,136, filed on Feb. 28, 2006, U.S. Provision Application No. 60/801,014, filed on May 17, 2006 and U.S. Provisional Application No. 60/810,390, filed on Jun. 2, 2006. The entire teachings of the above applications are incorporated herein by reference.

### BACKGROUND

Wind turbines are often used for generating electricity. A drawback of wind power is that wind can sometimes be inconsistent, resulting in inconsistent power generation. Water turbines that are employed in dams can generate electric power consistently. However, a dam is typically a very large and costly project to undertake.

### SUMMARY

The present invention provides a turbine apparatus which can be submersed in water and generate electric power from existing water currents.

The present invention can provide a submersible turbine apparatus including first and second buoyant turbine units that are connected to each other side by side, and laterally apart from each other. Each turbine unit can include turbine blades that are rotatably mounted about an elongate stationary axle. A lower elongate sealed chamber axles in a manner to provide a center of gravity centrally positioned below the laterally spaced buoyant first and second turbine units to stabilize the turbine apparatus when submersed.

In particular embodiments, the first and second turbine units can each include turbine blades that are rotatably mounted about the stationary axle by a bearing arrangement. The turbine blades can be rotatably coupled to an electric generator by a transmission. The electric generator and the transmission can be positioned within a sealed hollow cavity of the stationary axle. A clutch can be coupled between the transmission and the electric generator for controlling the rotational speed of the electric generator. The transmission can have a ratio of at least about 320:1, and in one embodiment, the transmission can be a torroidal drive transmission with a ratio of about 625:1. The electric generator can be rotated at a speed of at least about 2000 rpm. The bearing arrangement can include a radial bearing arrangement having magnetic repulsion bearings, and a thrust-bearing arrangement for absorbing thrust exerted on the turbine blades. The thrust-bearing arrangement can include a series of axially sequential thrust bearing surfaces for distributing thrust axially sequentially. The thrust-bearing surfaces can be in magnetic repulsion. The thrust bearing surfaces can be covered with a wear resistant covering. In one embodiment, the wear resistant covering can be diamond, and in another embodiment, the wear resistant covering can be silicon nitride.

The first and second turbine units and the lower chamber can be connected together by frame members. The lower chamber can include upstream and downstream ballast control. A controllable mooring system can controllably position the turbine apparatus when submersed. A cable can extend from the turbine apparatus for conveying electricity generated by the electric generator to a desired location. The cable can have a portion that is arranged in a spiral configuration to allow movement of the turbine apparatus. A sensor system can sense conditions within and surrounding the turbine apparatus, and a control system can control operation of the turbine apparatus based on the sensed conditions. The hollow cavity of the stationary axle can be about 3 meters in diameter and include an access hatch to allow a person to enter and walk inside the stationary axle. The turbine blades can have a lightweight shell covering a porous interior structure, and can be buoyant. Each turbine unit can have four turbine blades slanted at about a 14° angle. The turbine blades can be configured for bi-directional use. The turbine blades can have a diameter of about 30 meters to 50 meters. A desalinization device can be electrically connected to the electric generator.

The present invention can also provide a submersible turbine apparatus including a stationary axle, and turbine blades rotatably mounted about the stationary axle by a radial bearing arrangement. A thrust bearing arrangement can absorb thrust exerted on the turbine blades. The thrust bearing arrangement can have a series of axially sequential thrust bearing surfaces for distributing thrust axially sequentially.

In particular embodiments, the radial bearing arrangement can include magnetic repulsion bearings, and the thrust bearing surfaces can be in magnetic repulsion. The thrust bearing arrangement can include at least three opposed pairs of thrust bearing surfaces which can be covered with a wear resistant covering. The turbine blades can be buoyant, thereby reducing the load on the magnetic repulsion bearings of the radial bearing arrangement. An electric generator can be powered by the turbine blades. A desalinization device can be electrically connected to the electric generator.

The present invention can also provide a submersible turbine apparatus including an elongate stationary axle having a sealed hollow cavity. Turbine blades can be rotatably mounted about the stationary axle by a bearing arrangement and rotatably coupled to an electric generator by a transmission. The electric generator and the transmission can be positioned within the sealed hollow cavity of the stationary axle. The transmission can have a ratio of at least about 320:1 for increasing rotational speed to the electric generator.

In particular embodiments, a clutch can be coupled between the transmission and the electric generator for controlling the rotational speed of the electric generator. The transmission can be a torroidal drive transmission. In one embodiment, the transmission can have a ratio of at least about 400:1, and in other embodiments, the transmission can have a ratios of least about 500:1, or at least about 600:1. In one embodiment, the transmission can have a ratio of about 625:1. The electric generator can be rotated at a speed of at least about 2000 rpm. A desalinization device can be electrically connected to the electric generator.

The present invention can also provide a submersible turbine apparatus including a stationary axle, and a buoyant turbine rotatably mounted about the stationary axle. The turbine can have a central hub with a series of turbine blades extending from the hub to a cylindrical outer rim. The turbine blades can have a lightweight shell covering a porous interior structure.

The present invention can also provide a method of operating a turbine apparatus including submersing the turbine apparatus in a water current. The turbine apparatus can have first and second buoyant turbine units for being driven by the water current. The first and second turbine units can be connected to each other side by side, and laterally apart from each other. Each turbine unit can include turbine blades that are rotatably mounted about elongate stationary axle. A lower elongate sealed chamber can be connected to the first and second turbine units centrally below the stationary axles in a manner to provide a center of gravity centrally positioned below the laterally spaced buoyant first and second turbine units to stabilize the turbine apparatus when submersed.

In particular embodiments, the first and second turbine units can each include turbine blades that are rotatably mounted about the stationary axle by a bearing arrangement. The turbine blades of each turbine unit can be rotatably coupled to an electric generator by a transmission. The electric generator and the transmission can be positioned within a sealed hollow cavity of the stationary axle. The rotational speed of the electric generator can be controlled with a clutch coupled between the transmission and electric generator. The electric generator can be rotated by a transmission having a ratio of least about 320:1, and in one embodiment, the electric generator can be rotated with a torroidal drive transmission having a ratio of about 625:1. The electric generator can be rotated at a speed of at least about 2000 rpm. The turbine blades in each turbine unit can be supported with a radial bearing arrangement including magnetic repulsion bearings, and a thrust bearing arrangement can absorb thrust exerted on the turbine blades. The thrust bearing arrangement can include a series of axially sequential thrust bearing surfaces for distributing thrust axially sequentially. The thrust bearing surfaces can be in magnetic repulsion. The thrust bearing surfaces can be covered with a wear resistant covering. In one embodiment, the thrust bearing surfaces can be covered with diamond, and in another embodiment, the thrust bearing surfaces can be covered with silicon nitride.

The first and second turbine units and the lower chamber can be connected together by frame members. The lower chamber can be provided with upstream and downstream ballast control. The turbine apparatus can be controllably positioned with a controllable mooring system. A cable can be extended from the turbine apparatus for conveying electricity generated by the electric generator to a desired location. The cable can have a portion that is arranged in a spiral configuration to allow movement of the turbine apparatus. Conditions within and surrounding the turbine apparatus can be sensed with a sensor system, and operation of the turbine apparatus can be controlled with a control system, based on the sensed conditions. The hollow cavity of the stationary axle can have a diameter of about 3 meters and can include an access hatch to allow a person to enter and walk inside the stationary axle. The turbine blades can be provided with a lightweight shell covering a porous interior or structure, and can be buoyant. Each turbine unit can be provided with four turbine blades that are slanted at about a 14° angle. The turbine blades can be configured for bi-directional use. The turbine blades can have a diameter in the range of about 30 meters to 50 meters. A desalinization device can be electrically connected to the electric generator.

The present invention can also provide a method of operating a turbine apparatus including rotatably mounting turbine blades of the turbine apparatus about a stationary axle with a radial bearing arrangement. The turbine apparatus can be submersed in a water current. Thrust exerted on the turbine blades can be absorbed with a thrust bearing arrangement. The thrust bearing arrangement can include a series of axially sequential thrust bearing surfaces for distributing thrust axially sequentially.

In particular embodiments, the radial bearing arrangement can be provided with magnetic repulsion bearings, and the thrust bearing surfaces can be provided with magnetic repulsion. Thrust can be absorbed with the thrust bearing arrangement having at least three opposed pairs of thrust bearing surfaces which can be covered with a wear resistant covering. The load on the magnetic repulsion bearings of the radial bearing arrangement can be reduced by employing turbine blades that are buoyant. The electric generator can be powered with the turbine blades and a desalinization device can be electrically connected to the electric generator.

The present invention can also provide a method of operating a turbine apparatus including rotatably mounting turbine blades about a elongate stationary axle with a bearing arrangement. Stationary axle can have a sealed hollow cavity. The turbine blades can be rotatably coupled to an electric generator with a transmission. The electric generator and the transmission can be positioned within the sealed hollow cavity of the stationary axle. The transmission can have a ratio of at least about 320:1 for increasing rotational speed to the electric generator. The turbine apparatus can be submersed in a water current.

In particular embodiments, the rotational speed of the electric generator can be controlled with a clutch coupled between the transmission and the electric generator. The transmission can be a torroidal drive transmission. In one embodiment, the transmission can have a ratio of at least about 400:1, and in other embodiments, the transmission can have ratios of at least about 500:1, or at least about 600:1. In one embodiment, the transmission can have a ratio of about 625:1. The electric generator can be rotated at a speed of at least about 2000 rpm. A desalinization device can be electrically connected to the electric generator.

The present invention can also provide a method of operating a turbine apparatus including rotatably mounting a buoyant turbine about a stationary axle. The turbine can have a central hub, and a series of turbine blades can extend from the hub to a cylindrical outer rim. The turbine blades can have a lightweight shell covering a porous interior structure. The turbine apparatus can be submersed in a water current.

### BRIEF DESCRIPTION OF THE DRAWINGS

The foregoing will be apparent from the following more particular description of example embodiments of the invention, as illustrated in the accompanying drawings in which like reference characters refer to the same parts throughout the different views. The drawings are not necessarily to scale, emphasis instead being placed upon illustrating embodiments of the present invention.

FIG. 1 is a perspective view of one embodiment of an electric power generation system having an underwater or submersible turbine apparatus.

FIG. 2 is a schematic side sectional view of the turbine apparatus in FIG. 1.

FIG. 3 is a schematic drawing of a magnetic repulsion radial bearing.

FIG. 4 is a schematic drawing of a portion of a thrust bearing arrangement.

FIG. 5 is a schematic side sectional drawing of another embodiment of a turbine apparatus having a funnel.

FIG. 6 is a perspective drawing of another embodiment of an underwater turbine apparatus having two turbine units.

FIG. 7 is a schematic sectional view of one turbine unit of the embodiment of FIG. 6.

FIG. 8 is a perspective view of still another embodiment of an underwater turbine apparatus having two turbine units.

FIG. 9 is a side sectional view of one turbine unit of the embodiment of FIG. 8.

FIG. 10 is a partial sectional view of components of one turbine unit.

FIG. 11 is a front view of yet another embodiment of an underwater turbine apparatus having two turbine units.

FIG. 12 is a perspective view of the embodiment of FIG. 11.

FIG. 13 is a top sectional view of the embodiment of FIG. 11.

FIG. 14 is a partial perspective view of an embodiment of a turbine.

FIG. 15 is a sectional view of the turbine of FIG. 14.

FIG. 16 is a perspective view of a portion of an embodiment of another turbine.

FIGS. 17 through 19 depict portions of turbine blade construction.

FIG. 20 depicts a portion of an embodiment of a portion of a magnetic thrust bearing arrangement.

FIG. 21 is a perspective view of an embodiment of a transmission.

FIG. 22 is an exploded view of the transmission of FIG. 21.

FIG. 23 is a schematic drawing of an embodiment of a collapsible funnel in a closed position.

FIG. 24 is a schematic drawing of the collapsible funnel of FIG. 23 in an open position.

FIGS. 25 and 26 are schematic drawings of embodiments of electric power generation systems.

FIG. 27 is a schematic drawing of an embodiment of a data acquisition, sensing and control system.

FIG. 28 is a schematic drawing of a desalinization system.

FIG. 29 is a schematic drawing of another embodiment of a desalinization system.

### DETAILED DESCRIPTION

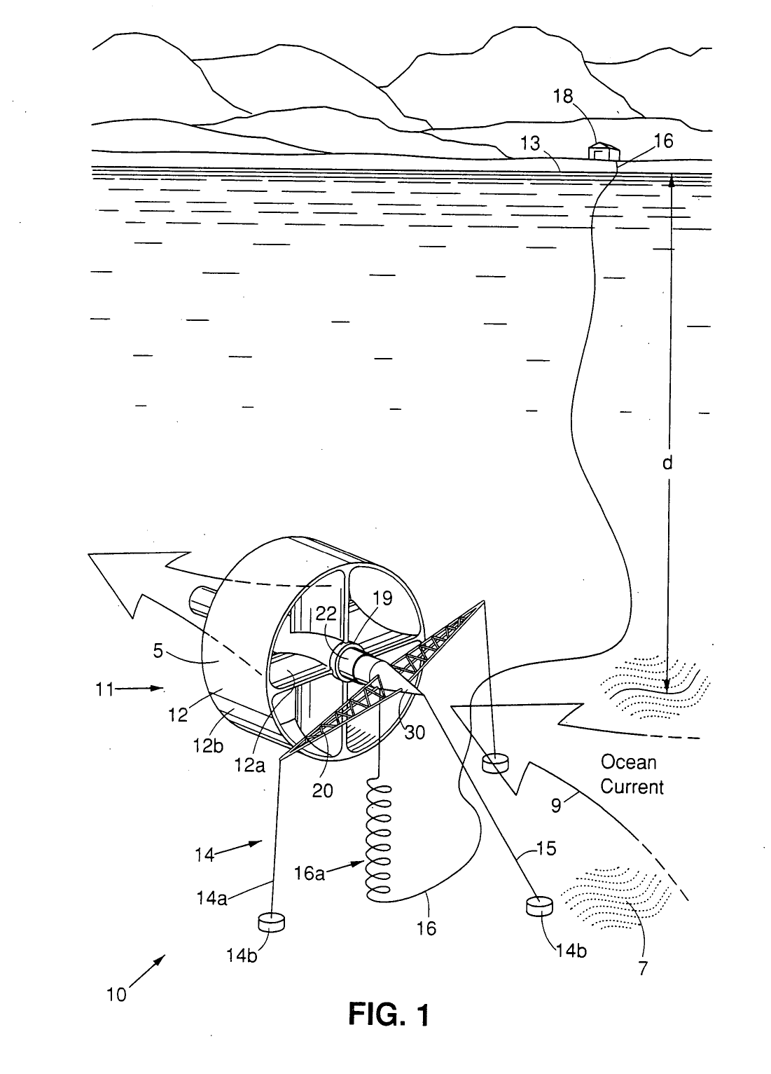

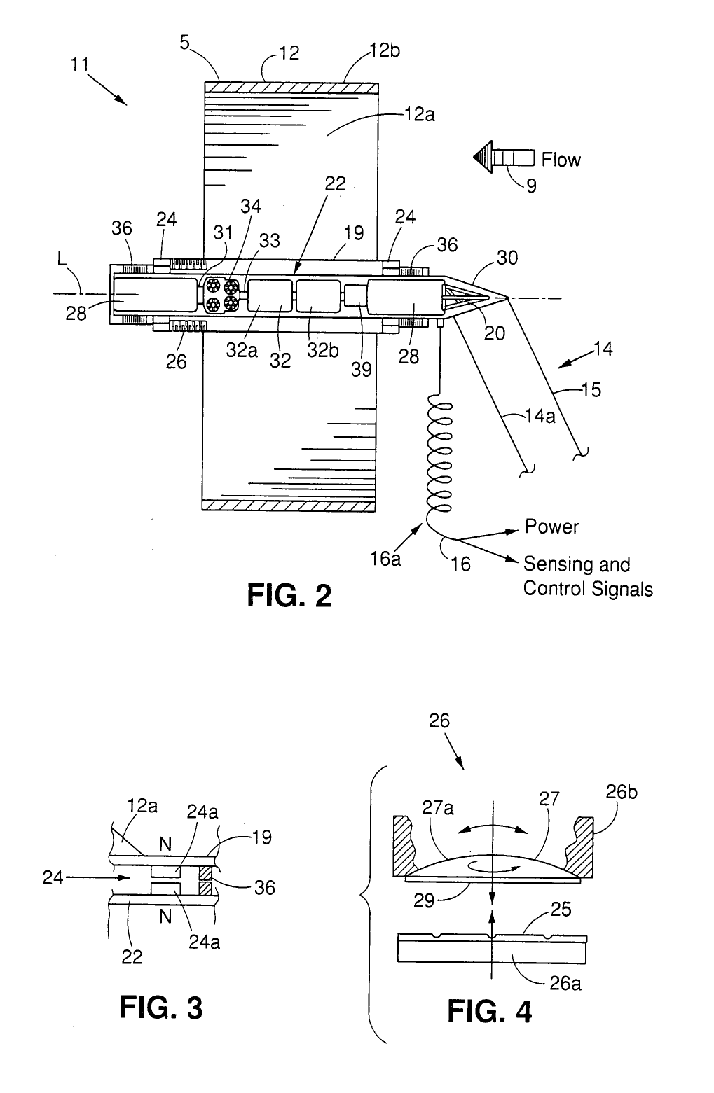

Referring to FIGS. 1 and 2, electric power generation system 10 can include an underwater or submersible turbine apparatus 11 for generating electricity from a flowing water current 9. The turbine apparatus 11 can remain underwater for long periods of time, and can then be raised to the surface of the water 13 periodically for maintenance. A power transmission cable 16 can convey the generated electricity to a desired location, for example, a station or building 18 on shore for distribution to customers. In some embodiments, the cable 16 can be connected to a single use device, or building, on land or water, for example, a desalinization plant or device.

The turbine apparatus 11 can have a turbine unit 5 with a turbine, propeller or impeller 12 that is rotatably mounted about a stationary hub or axle chamber 22, and its longitudinal central axis L, by a radial bearing arrangement having radial bearings 24. The axle chamber 22 can be a sealed generally tubular hollow elongate member and the turbine 12 can be mounted concentrically about the axle chamber 22. The axle chamber 22 can contain two spaced apart ballast units 28 for controlling the buoyancy of the turbine apparatus 11, as well as a transmission 34, an electric generator 32 and a brake 39. The radial bearings 24 can be magnetic levitation or repulsion bearings to minimize friction forces, and have bearing members 24a that are magnetized to repel each other, for example, having both north poles N, as shown in FIG. 3. Alternatively south poles S can be employed. In addition, in other embodiments, radial bearings 24 can be other suitable bearings including bushings, journal bearings, roller bearings, needle bearings, ball bearings, etc. Seals 36 can seal out water from the axle chamber 22. The axle chamber 22 can be pressurized with a suitable gas, which can provide structural, sealing and buoyancy properties and benefits. The turbine 12 can have a series of turbine, propeller or impeller blades 12a which extend radially outwardly from a central axle, sleeve, bushing, tube or hub 19. The outer periphery of the turbine blades 12a can be secured or connected to an outer rim 12b, which can be generally cylindrical in shape. The flowing water current 9 engages the turbine blades 12a and rotates the turbine 12 about the axle chamber 22. Depending upon the speed of the water current 9, the turbine 12 can in some instances rotate near or at about 12 rpm. The amount of electric power generated by electric generator 32 can be proportional with cubic power to the velocity and intercept area of the water current 9.

Rotation of the turbine 12 can drive an input shaft 31 to the transmission 34 to convert low speed high torque rotation provided by the turbine 12 to high speed low torque rotation at output shaft 33. In some embodiments the transmission 34 can range from about a 1:25 ratio to a 1:30 ratio, so that the output shaft 33 can be rotated at about 300 rpm. In some embodiments, higher ratios can be used, for example, above about 1:320, such as about a 1:625 ratio which can be provided by a torroidal drive transmission to rotate the electric generator 32 at speeds above 300 rpm. The low torque high speed rotation of output shaft 33 can drive the electrical generator 32 for generating electricity. The electrical generator 32 can have more than one generating unit, with two generating units, 32a and 32b rotatably coupled together being shown in FIG. 2. Brake 39 can be provided for braking or controlling the rotational speed.

Electricity generated by the electrical generator 32 can be provided to a desired location through cable 16. In addition, cable 16 can contain components to convey signals for sensing the operation of the turbine apparatus 11 and provide control signals for controlling it's operation. The cable 16 can include a portion that is arranged in a spiral or helical configuration 16a for providing slack or excess cable 16 that is in a suitable position adjacent to turbine apparatus 11, and has a suitable length to allow the turbine apparatus 11 to be moved around relative to the floor or bottom 7 of the body of water 13, such as the ocean.

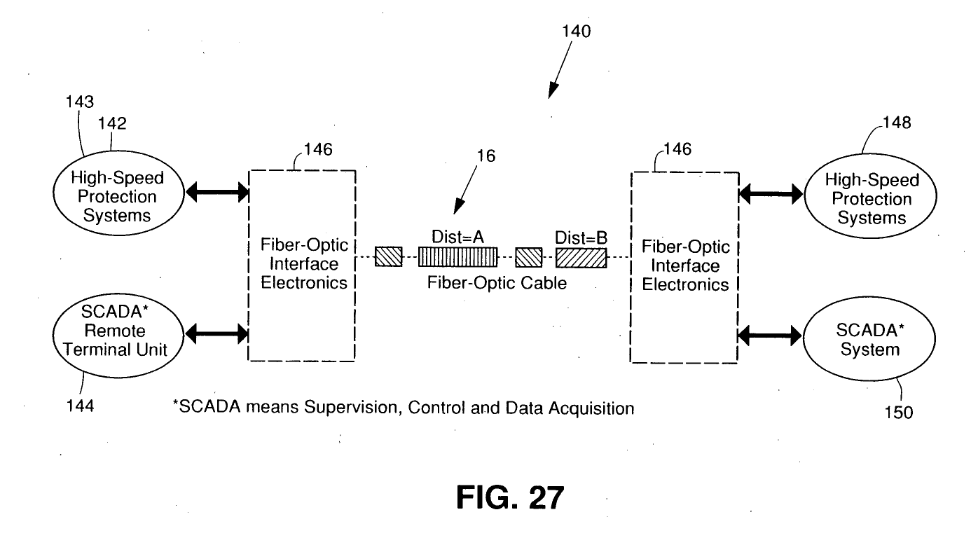

The turbine apparatus 11 can be moored, anchored, or secured to the bottom 7 by a controllable mooring system 14 that is located a distance or depth d below the water surface 13. The mooring system 14 can hold the turbine apparatus 11 down against buoyant forces, as well as lift forces caused by water flowing over turbine apparatus 11. When in the ocean, the distance or depth d can be as much as 100 m to 300 m below the surface of the water 13, which is typically well below shipping lanes, large fish populations and plankton layers. At such depths, the water pressure on the turbine apparatus 11 can be about 200 tons/m². The mooring system 14 can include a central line 15 and side lines 14a which are secured to the axle chamber 22 at the tapered nose 30 and support bracket 20, on a first or front upstream end. The lines 15 and 14a can be secured to the bottom 7 by mooring bases 14b, which can include actuated or motorized mechanisms for controlling the length of lines 15 and 14a, to control the depth and positioning of turbine apparatus system 11. Alternatively, the nose 30 and support bracket 20 can include mechanisms for controlling lines 15 and 14a. The turbine apparatus 11 can include sensors 142 (FIG. 27) for sensing conditions within and surrounding the turbine apparatus 11, including position, orientation, altitude, pitch, roll, yaw, depth, voltage and electric current output, frequency, electrical load on components, temperature of components such as bearings, generators, conductors, housings, transmissions, etc., water current flow speed and direction, acoustic noise frequency patterns and resonances, sonar signals (friend or foe), rotational speed of rotating components such as turbine 12, transmission 34 and generator 32, torque, pressure, stress or force, etc. Depending upon the particular conditions sensed, operation of the turbine apparatus 11 can be controlled appropriately with a control system 148 and control devices 143 (FIG. 27).

The force of the flowing water current 9 against the turbine blades 12a exerts a thrust force on the turbine 12, which can be absorbed by a thrust bearing arrangement 26. Referring to FIG. 4, the thrust bearing arrangement 26 can include a series of axially sequential opposed thrust absorbing bearing plates or members 26a and 26b which rotate relative to each other, and can be lubricated by the ambient water. The thrust bearing arrangement 26 can be located at or near a second or rear downstream end of the axle chamber 22. The thrust absorbing member 26b can have a rotatable and pivotable member 27 positioned in a pivotable seat 27a. The opposed thrust absorbing bearing faces or surfaces 25 and 29 of thrust absorbing members 26a and 26b can be covered or coated with wear or abrasive resistant coverings or coatings, for example, silicon nitride, diamond or diamond like material. The axially sequential pairs of opposed thrust bearing surfaces 25 and 29 can distribute and absorb thrust axially sequentially so that each pair of opposed surfaces 25 and 29 absorbs a portion of the total thrust.

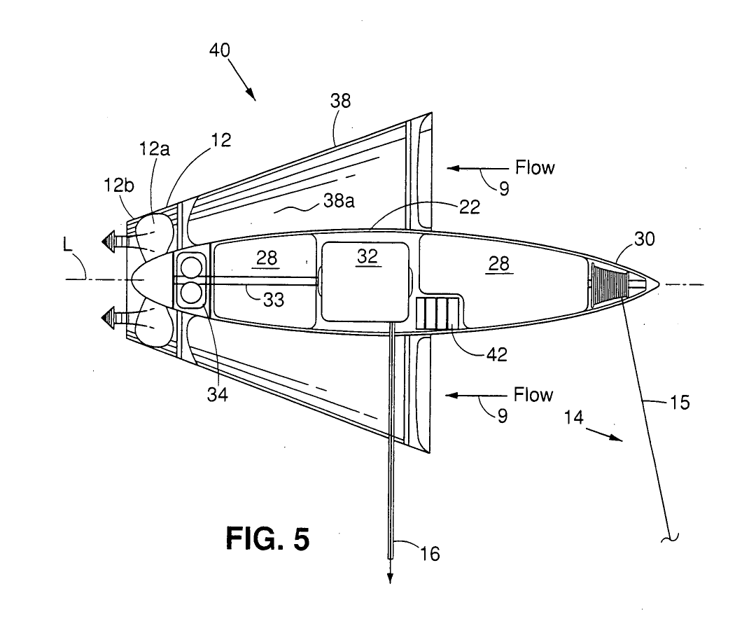

Referring to FIG. 5, turbine apparatus 40 is another embodiment of a turbine apparatus which includes a funnel 38 having a narrowing inlet 38a for directing the water current 9 to the turbine 12 located at the downstream end of the axle chamber 22, and increasing the speed of the water. A battery 42 can be contained within the axle chamber 22 for providing power to turbine apparatus 40, including sensors 142 and control devices 143 (FIG. 27). The axle chamber 22 can have a curved or tapered nose 30 and surfaces to reduce flow resistance.

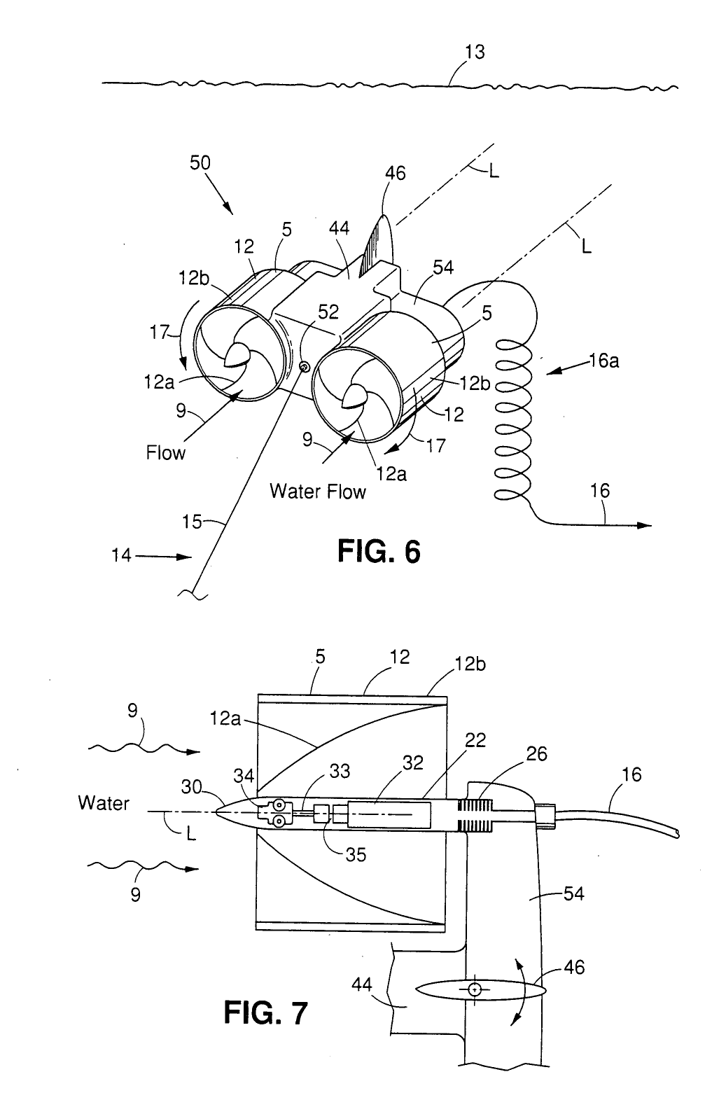

Referring to FIGS. 6 and 7, turbine apparatus 50 is another embodiment of a turbine apparatus which includes a sealed central body or chamber 44 to which two turbine units 5 are mounted on opposite sides of the central chamber 44 with the central axes L of the axle chambers 22 being parallel to each other. The central chamber 44 and the axle chambers 22 can be pressurized. The water current 9 enters the turbines 12 at a first or front upstream end of the turbine apparatus 50. The turbines 12 can be rotated in opposite rotational directions 17 in order to minimize, cancel out, or balance forces caused by rotating components. The central chamber 44 can have a controllable rudder 46 located at a second or rear downstream end 54 for helping control the movement, position, and or orientation of the turbine apparatus 50. The axle chambers 22 of each turbine unit 5 can extend forwardly or upstream from the down stream end 54. The thrust bearing arrangements 26 can be located at and transfer thrust from the turbines 12 to the downstream end 54 of the central chamber 44. A clutch or brake 35 can be connected to the output shaft 33 of the transmission 34 and positioned between the transmission 34 and the electric generator 32 in each turbine unit 5 for rotating the electric generator 32 with a constant or consistent rotational speed, despite variations in rotational speed of the turbines 12. The clutch 35 can be a hydrodynamic coupling. Alternatively, other suitable clutches can be employed. The mooring system 14 can include a single line 15 connected to a tether location 52. Additional lines 14a can also be employed.

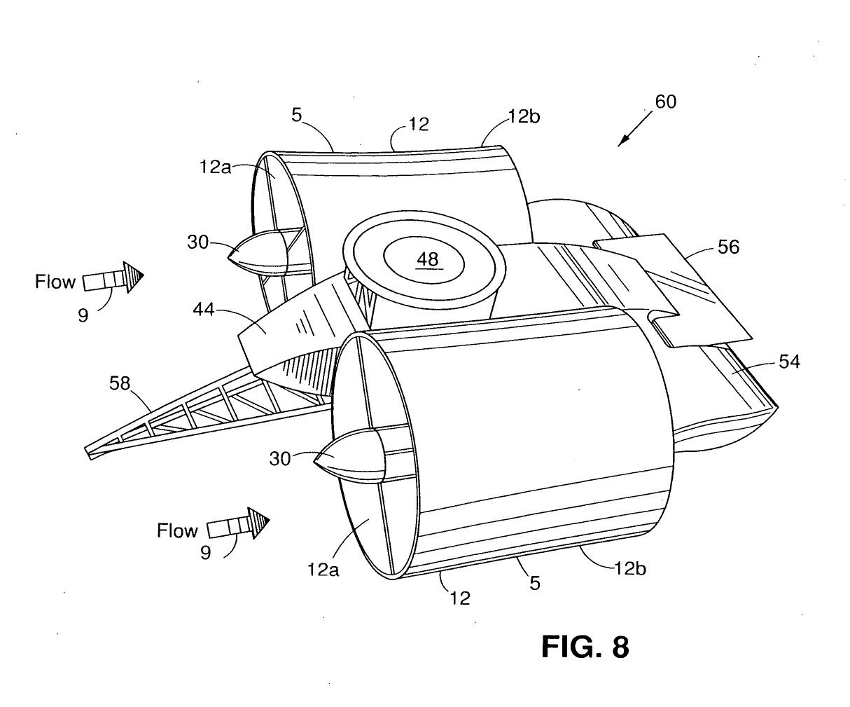

Referring to FIG. 8, turbine apparatus 60 is another embodiment of a turbine apparatus. Turbine apparatus 60 differs from turbine apparatus 50 in that a controllable horizontal flap 56 can be positioned at the downstream end 54 of the central chamber 44 to help control movement, position, and or orientation. In embodiments where the turbines 12 are large, for example, about 30 m to 50 m in diameter, a helicopter pad 48 can be positioned on the top surface of the central chamber 44 to allow a helicopter to land on the turbine apparatus 60 when brought to the surface of the water 13. The mooring system 14 can be secured to a tether bracket 58 extending upstream or forwardly from the central chamber 44.

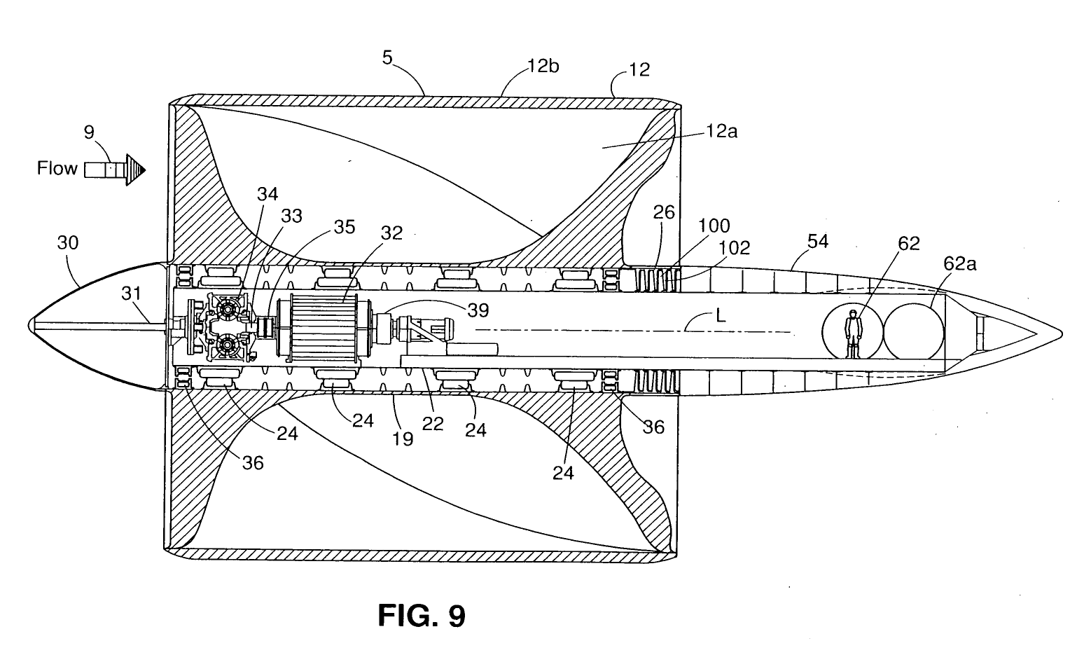

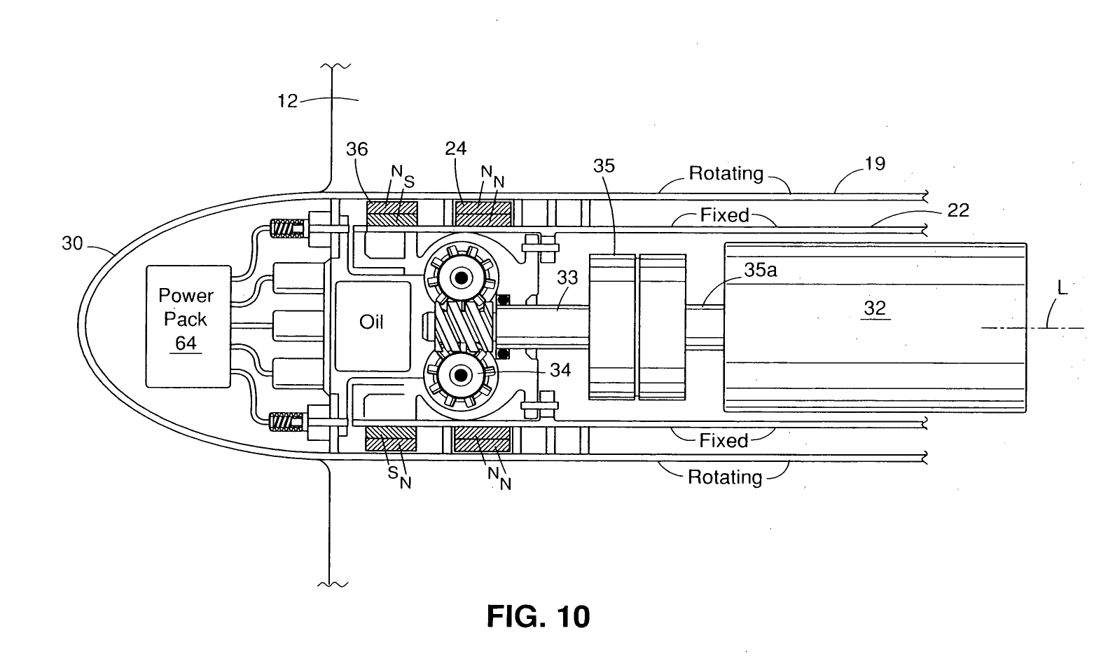

Referring to FIG. 9, the nose 30 of each turbine unit 5 in turbine apparatus 60 can include an input shaft 31 that rotates with the turbine 12, and is connected to the transmission 34 at the first or front upstream axial end of the axle chamber 22. A brake 39 can be coupled to the electric generator 32. The turbine 12 can be rotatably mounted to the axle chamber 22 by four sets of magnetic radial bearings 24 axially spaced apart from each other along the longitudinal axis L. The axle chamber 22 can be about 3 m in diameter, and have a hatch 62a to allow a person 62 to enter and walk inside for maintenance purposes. Referring to FIG. 10, the clutch 35 can be rotatably coupled to the generator 32 by clutch output shaft 35a. A power pack 64 can provide power for operating aspects of the turbine unit 5. The seals 36 can be magnetic ferro-fluidic seals having north N and south S poles for sealing out water from entering the axle chamber 22. Other suitable seals can also be employed.

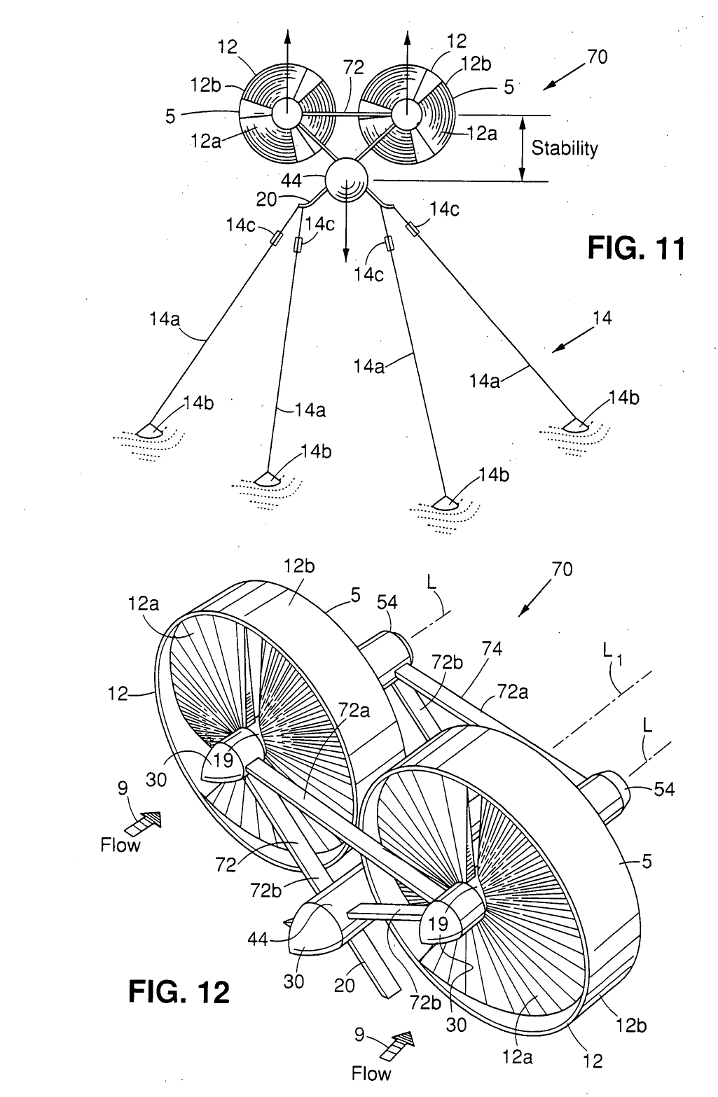

Referring to FIGS. 11 through 13, turbine apparatus 70 is another embodiment of a turbine apparatus. Two turbine units 5 can be secured laterally side by side and parallel to each other in a spaced apart manner, by a first upstream or front frame 72, and a second downstream or rear frame 74. An elongate central chamber 44 having a longitudinal central axis L₁ can be secured by the upstream 72 and downstream 74 frames below the elongate axle chambers 22 of the turbine units 5 and centrally positioned in an upside down or inverted triangular configuration. The central chamber 44 can be generally tubular or cylindrical. The longitudinal axes L of the axle chambers 22 can be parallel to the longitudinal axis L₁ of the central chamber 44. The frames 72 and 74 can be generally triangular in shape when viewed in the axial end directions (FIG. 11). Each frame 72 and 74 can have a lateral or horizontal cross piece 72a connecting the axle chambers 22 together, and inwardly downwardly angled legs 72b connecting the axle chambers 22 to the central chamber 44, at first or front upstream and second or rear downstream ends. The axle chambers 22 can be hollow and can have buoyancy. The relative buoyancy or lift of the spaced apart axle chambers 22 located above the central chamber 44 can be chosen or regulated in comparison to the weight of the central chamber 44 to centrally position the center of gravity of the turbine apparatus 70 below and centrally positioned relative to the spaced apart buoyant axle chambers 22. The spaced apart axle chambers 22 can provide a lateral plane of buoyancy extending therebetween, and have a center of buoyancy. The lowered center of gravity directed downwardly in the upside down triangular configuration between the two spaced apart buoyant axle chambers 22 can stabilize the turbine apparatus 70 and help keep it in an upright operating position. The elongate configuration of the axle chambers 22 and central chamber 44 relative to the diameter of turbines 12 can also promote stability. The frames 72 and 74 can also be shaped or configured for water to flow past in a manner that contributes to stabilization. One or more gyroscopes can also be positioned in axle chambers 22 and/or central chamber 44 to provide further stability.

The mooring system 14 can include four lines 14a for stabilizing the turbine apparatus 70. Control of the lines 14a can be provided in the bases 14b or at locations 14c near bracket 20. The four lines 14a can be connected to only the first or front upstream end of turbine apparatus 70, or can be connected at both the first or front upstream and second or rear downstream ends. The mooring system 14 and the cable 16 can include quick connect and disconnect features, which can be powered.

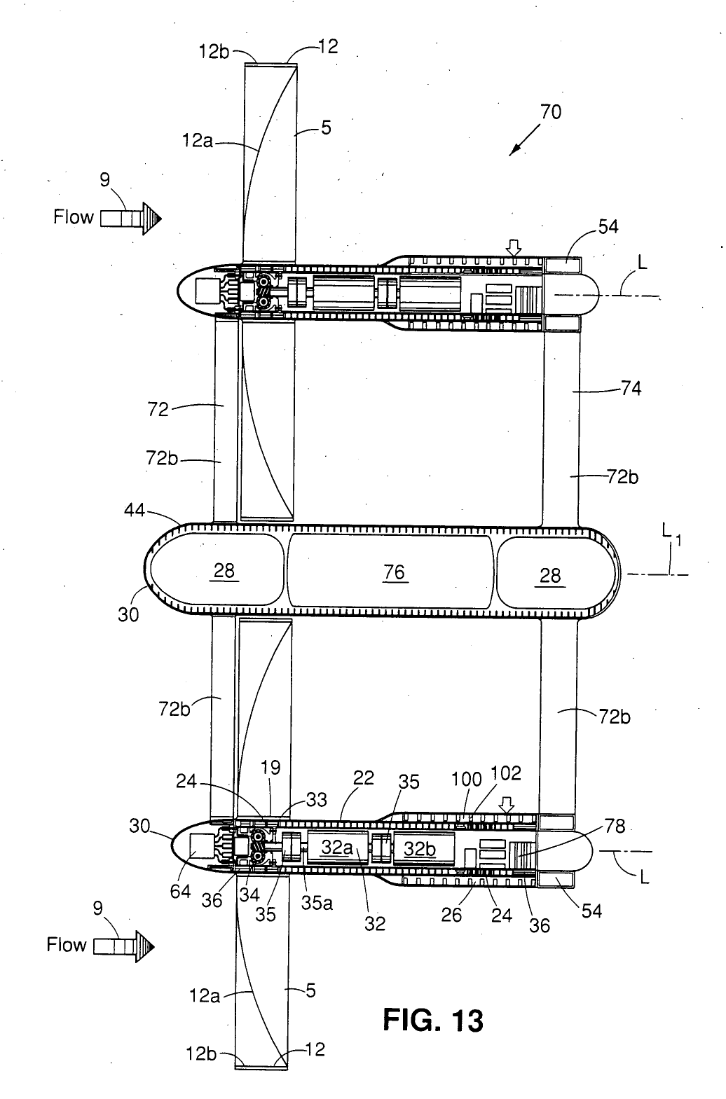

Referring to FIG. 13, each generator 32 can have a single or first generating unit 32a, and can also optionally include a second generating unit 32b that can be rotatably coupled to the first generating unit 32a by a clutch 35. Each axle chamber 22 can contain support equipment 78, which can include maintenance equipment and spare parts. The axle chambers 22 can have an axial length to diameter ratio of about 13 to 1. In one embodiment, the axle chambers 22 can have a diameter of about 3 m and have an axial length of about 40 m. The nose 30 can have a diameter of about 5 m. The turbine 12 can have a diameter to axial length ratio of about 8 to 1. In one embodiment, turbines 12 can have a diameter of about 40 m and an axial length of about 4.8 m. The diameter of the turbines 12 relative to the axial length of the axle chambers 22 can have a ratio of about 1 to 1. The short axial length of the turbines 12 through which the water current 9 passes can minimize the thrust forces exerted on the turbines 12. In addition, having a cylindrical rim 12b with the surfaces that are aligned or parallel with the water current 9 can also minimize thrust forces. Depending upon the application at hand, the diameter of turbines 12 can often range from about 30 m to 50 m. It is understood that larger or smaller diameters can be employed.

The central chamber 44 can include spaced apart first or front upstream and second or rear downstream ballast/buoyancy units 28, and a middle region 76 which can include pressurized air or gas tanks. The central chamber 44 can have an axial length to diameter ratio of about 5.5 to 1. In one embodiment, the central chamber 44 can have a an axial length of about 45 m and a diameter of about 8 m. The ballast or buoyancy of units 28 can be changed or controlled by filling with water, or expelling water and filling with gas. Control of the ballast/buoyancy units 28 can raise the turbine apparatus 70 to the surface of the water 13, for example, for travel or maintenance, or submerge apparatus 70 to the desired depth d for operation. In addition, ballast/buoyancy units 28 can have first or front upstream end, and second or rear downstream end control, to control tilt to raise or lower first or front upstream or second or rear downstream ends, or to control the depth of operation or submersion or lift forces caused by water current 9 flowing over the turbine apparatus 70. Pumps also can be used to introduce and expel water. Region 76 can also include electrical equipment such as control equipment and transformers. Auxillary batteries can be used for providing power if needed.

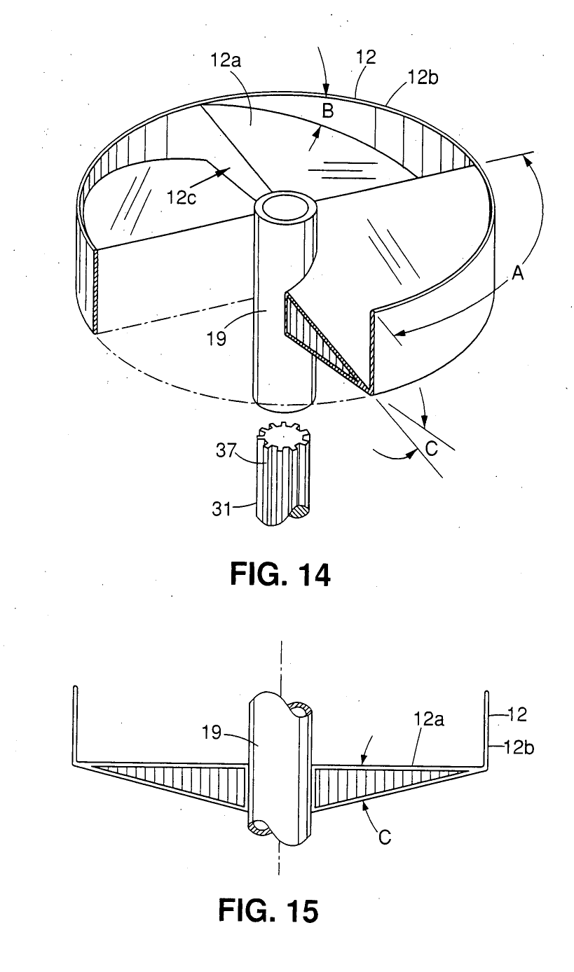

Referring to FIGS. 14 and 15, the hub 19 of turbine 12 can be configured to be rotationally secured or coupled to an input shaft 31 having splines 37. Alternatively, the hub 19 can be secured by other suitable methods, including keys and keyways. The turbine 12 can have four turbine, propeller or impeller blades 12a, each extending around the hub 19 an angle of A, typically about 90°, and inclining at an angle B, for example about 30°. Each turbine blade 12a can be thicker at the hub 19 and taper to the rim 12b at an angle C, for example 10°. Large openings 12c can be formed between each blade 12a to allow the passage of fish and other marine life. If desired, turbines without a rim 12b can be employed.

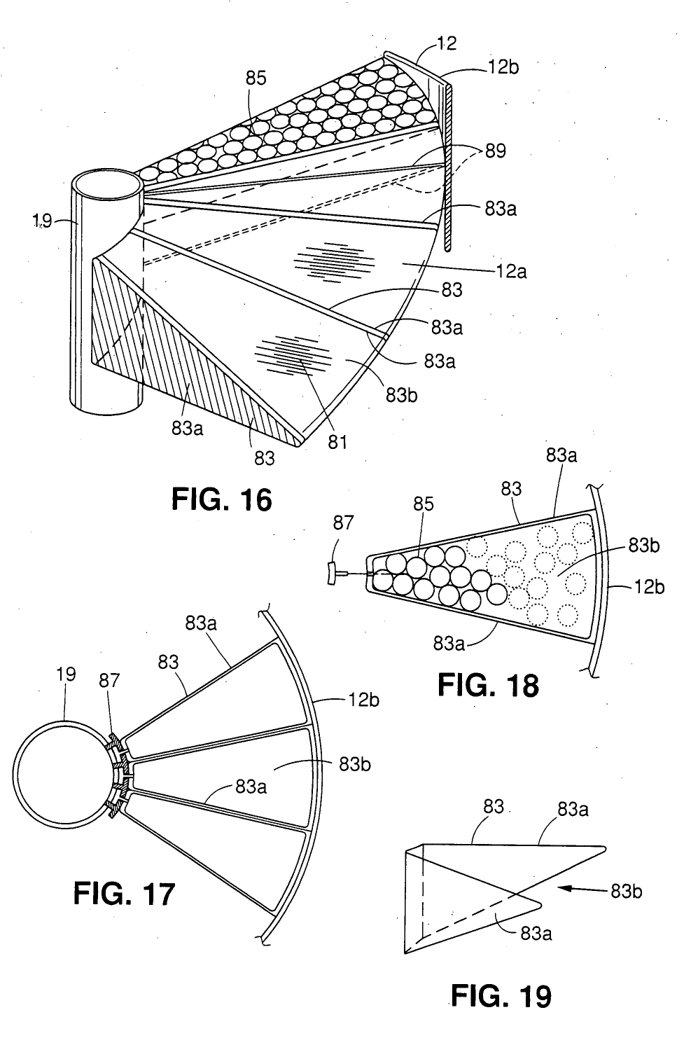

Referring to FIGS. 16 through 19, the turbine 12 can be formed of an ultra light construction in a configuration that is functionally bi-directional, thereby making it suitable for operation in tidal waters. In bi-directional use, a second set of thrust bearings 26 can be added for absorbing thrust on the turbine 12 from the opposite direction. Each turbine blade 12a can be formed by a series of thin lightweight composite material webs 83 such as carbon fiber, having side walls 83a with a gap or space 83b therebetween. The webs 83 can be mounted or secured to the hub 19 and rim 12b, and adjacent to each other. The side walls 83a can be oriented in the axial or water current 9 flow direction. The spaces 83b can be filled with hollow tubes 85 which can be bonded or glued in place, and also oriented in the water current 9 flow direction. This can form a rigid porous or honeycomb interior and can allow the turbines 12 to be buoyant, or weightless in the water, thereby reducing the load on the radial bearings 24. The tubes 85 can be lightweight, and can be formed of composite material, plastic, fiberglass, or carbon fiber, and can be circular as shown, or have other geometrical shapes, such as polygonal, square, hexagonal, etc. A shell, skin or coversheet 81 of composite material such as carbon fiber can be bonded or glued to cover the webs 83 and the tubes 85. The rim 12b can also be made of a suitable porous structure. The webs 83 and coversheet 81 can be about 0.1 mm thick or other suitable thicknesses. In one embodiment, the turbine blade 12a can be sloped or inclined over the angle A (FIG. 14) at about 14′. A series of guy members, wires or spokes 89 (FIG. 16) can connect the hub 19 with the rim 12b for increasing the strength and stiffness of the turbine 12. The spokes 89 can be spaced at selected intervals and can be covered by the coversheet 81. If desired, the webs 83 can be secured to the hub 19 with fastening devices 87 such as a key-like attachment. It is understood that the number of turbine blades 12a, and the size and slope of the turbine blades 12a can be varied depending upon the application at hand. In one embodiment, the turbine blades 12a can extend about 120°. Turbine 12 can be also made of other suitable materials, including metals, such as steel, aluminum, and titanium, etc., and the porous interior can be formed by other suitable materials, including such suitable metals.

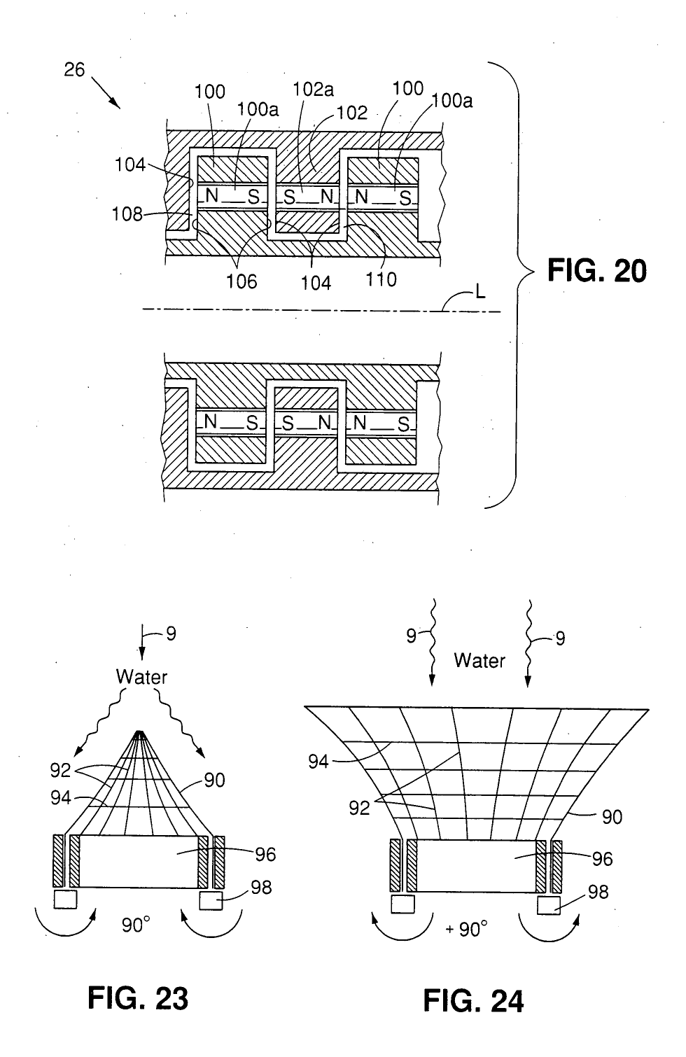

Referring to FIG. 20, each thrust bearing arrangement 26 can include a series of stationary circular or annular thrust absorbing bearing plates, fins, projections, or members 100 extending radially outwardly from an axle chamber 22, or a member connected to an axle chamber 22. The stationary thrust plate members 100 can also extend from a member from, or be connected to the downstream end 54 of the turbine apparatus 70. The stationary thrust plate members 100 can extend within spaces 108 that are located between rotating circular or annular thrust absorbing bearing plates, fins, projections, or members 102 extending radially inwardly from hub 19, or from a member that is secured, connected to, or otherwise transfers thrust from hub 19 or turbine 12. The rotating thrust plate members 102 extend within the spaces 110 between the stationary thrust plate members 100, so that the thrust plate members 100 and 102 can be arranged or assembled in an alternating interlocking manner adjacent to each other. The thrust plate members 100 and 102 can have equal heights and thicknesses, and the spaces 108 and 110 can have equal widths and depths.

The stationary thrust plate members 100 can have thrust absorbing bearing faces or surfaces 106, which face or oppose thrust absorbing bearing faces or surfaces 104 on the rotating thrust plate members 102. The surfaces 104 and 106 can be covered or coated with a wear or abrasive resistant covering or coating such as silicon nitride or diamond. The stationary thrust plate members 100 can be magnetically charged, or can include one or more magnetic members 100a, in which the north pole N is at or on one face 106, and the south pole S is at or on the opposite face 106. Each stationary thrust plate member 100 can have the same magnetic poles facing the same direction as shown in FIG. 20. The rotating thrust plate members 102 can be magnetically charged, or can include magnetic members 102a, in which the north pole N is at or on a face 104 which faces the north pole N of the face 106 of a stationary thrust plate member 100, and the south pole S is at or on an opposite face 104 which faces the south pole S of the face 106 of the stationary thrust plate member 100. As a result, the opposed north poles N and the opposed south poles S of the thrust plate members 100 and 102 repel each other so that the rotating thrust plate members 102 can rotate past the stationary thrust plate members 100 with reduced, little or no contact between faces 104 and 106. Ambient water can be allowed to occupy the spaces between the thrust plate members 100 and 102 for lubrication purposes. The water can also serve as a coolant. Since the repulsion of the stationary 100 and rotating 102 thrust plate members can be on or against both upstream and downstream faces 104 and 106, the thrust bearing arrangement 26 can absorb thrust in two directions, in both upstream and downstream directions, thereby allowing turbine apparatus 70 to run each turbine 12 in two rotational directions to generate electricity from tidal currents, where the currents switch directions when the tide changes. As a result, turbine apparatus 70 can be placed in a single direction water current 9 such as a river or an ocean current, or a two directional water current 9, such as a tidal current. The thrust plate members 100 and 102 can have a polymeric elastic flexible sheath on which tiles are mounted. The tiles can be wear or abrasive resistant, or can have wear or abrasive resistant coatings such as silicon nitride or diamond, and can be wedge shaped, for example have a 2°-5° angle, which can suck or draw in water for lubrication.

Depending upon the size and design of the turbine 12, the thrust forces exerted on the thrust bearing arrangement 26 in some embodiments can be on the order of 10,000 tons. The thrust bearing arrangement 26 can absorb the large thrust forces by including multiple thrust plate members 100 and 102 that are positioned axially sequentially, so that each thrust plate member pair 100 and 102, absorbs a portion of the total thrust force. The total thrust force can be distributed or divided between the multiple thrust plate member pairs 100 and 102 in an axially sequential manner. The distribution of a portion of the total thrust to each thrust plate member pair 100 and 102, allows the use of multiple thrust plate members 100 and 102 to collectively absorb or resist large thrust forces. The number of the thrust plate members 100 and 102 of a particular size and magnetic strength or power, can be chosen depending upon the size and design of the turbine 12. Typically there are more than two thrust plate members 100 or 102, and usually more than three, often, five or more thrust plate members 100 or 102 are employed. Some embodiments can have ten pairs of thrust plate members 100 and 102. In addition, there can be one more thrust plate member 100 than member 102, or vice versa, depending upon the sequential arrangement and configuration. For example, thrust plate members 100 can be positioned at both ends of thrust bearing arrangement 26, or vice versa. The size and diameter of the thrust plate members 100 and 102, as well as the strength of the magnetic members 100a and 102a, can be selected on the basis of the amount of thrust that each thrust plate member pair 100 and 102 is required to absorb. In one embodiment, the magnetic members 100a and 102a can be electromagnets in which the power can be controlled depending upon the thrust forces that need to be absorbed. For example, a tidal current increases and decreases in speed as the tide ebbs and flows. The power to the magnetic members 100a and 102a can be increased or decreased depending upon a sensed measurement by sensors, such as sensed thrust forces, sensed current speeds, sensed rotational speed (rpm) of the turbine 12, etc. Although the thrust absorbing surfaces 104 and 106 are shown to be perpendicular to axes L, in some embodiments, the thrust absorbing surfaces 104 and 106 can be angled, curved, or combinations thereof.

Components of turbine apparatus 70, including turbines 12, that are exposed to water can be made of material or have a covering, coating, surface, or treated with agents that are phobic to, or resist or prevent the growth of sea plants, algae, sea creatures, barnacles, etc. The axle chambers 22 and central chamber 44 can be filled with a noble or inert gas, for example helium, to prevent oxidation of components.

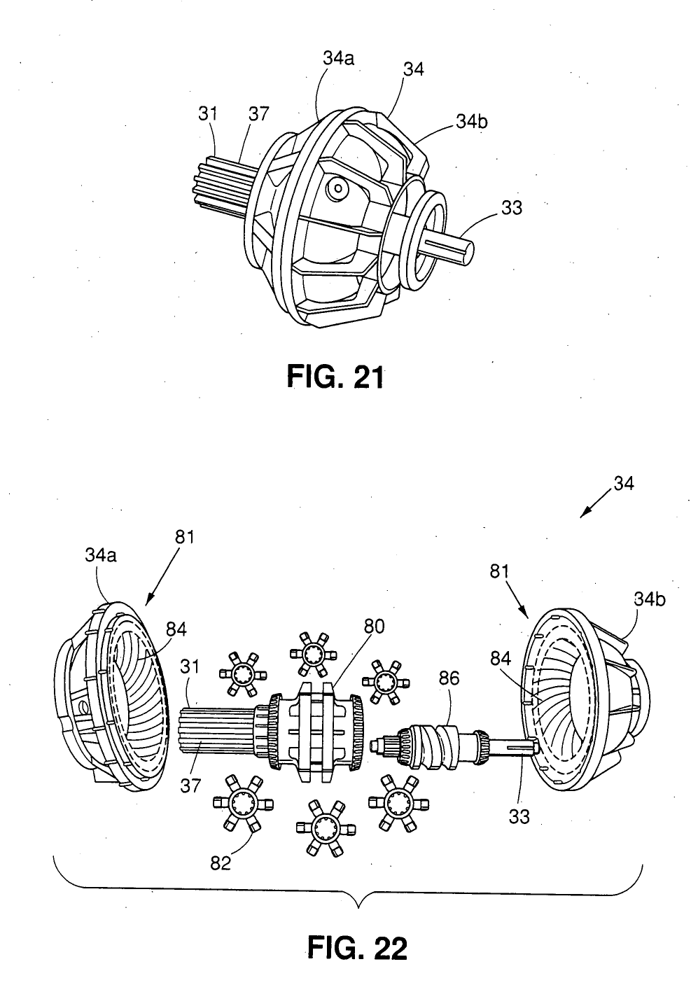

Referring to FIGS. 21 and 22, the transmission 34 can be a torroidal drive transmission having housing members 34a and 34b which are assembled together. Input shaft 31 can extend from housing member 34a and have a worm gear 80 positioned within the interior 81 of the transmission 34. The input shaft 31 is also connected to turbine 12. Output shaft 33 can extend from housing member 34b and have a worm gear 86 of smaller diameter positioned within the interior 81. The worm gear 80 can engage a series of spinning rolling elements 82 which can also engage and drive the worm gear 86 on the output shaft 33. The housing members 34a and 34b can include grooves or contours 84 which engage the elements 82. The elements 82 are driven by the high torque low rotational speed of the input shaft 31 and worm gear 80, and convert or transfer this rotation to the worm gear 86 to turn the output shaft 33 at a low torque high rotational speed. The transmission 34 can be a torrodial drive transmission from A-XYZ Transmission Systems, LLC, 22 Deer Run Road, Lincoln, Mass. 01773, and can have a design or features similar to or including those described in U.S. Pat. Nos. 5,784,923, 5,863,773 and 7,025,705, the contents of which are incorporated herein by reference in their entirety. Depending on the situation at hand, different ratios can be chosen, for example about 25:1, about 30:1 or between about 25:1 and 30:1, at or above about 300:1 such as at or above about 320:1, at or above about 400:1, at or above about 500:1, at or above about 600:1, and in some embodiments at about 625:1. In addition, higher ratios can be employed, and transmissions can be used in series. It is understood that transmission 34 can be of other types of transmissions.

When transmission 34 has a high gear ratio, the electric generator 32 can be rotated at high speeds, for example, above 300 rpm. In some instances, speeds of at least about 2000 rpm are desirable. In some embodiments, speeds can be at least about 3000 rpm, 4000 rpm, 5000 rpm, 6000 rpm, 7000 rpm, 8000 rpm, 9000 rpm, 10,000 rpm, 12,000 rpm, or 15,000 rpm. In some embodiments, about 18,000 rpm can be employed. Electric generator 12 can include rotating components and windings formed of light weight materials. For example, conductive components, such as windings can be formed of light weight conductive materials, such as carbon. By having light weight rotating components, the generator 32 can be run at high speed while minimizing vibration and inertial forces. Generator 32 can be sized to generate different amounts of power, for example, 5 mW, 10 mW, 20 mW, 20 mW. When generator 32 has two generating units 32a, 32b, each generating unit 32a and 32b can be the same size, for example 5 mW. Electric generator 32 is sized to fit within the interior of axle chamber 22.

Referring to FIGS. 23 and 24, in some embodiments, a collapsible funnel 90 can be positioned upstream of the turbine 12 to increase the speed of the water current 9. The funnel 90 can have a series of poles or supports 92 which are connected, covered or secured to a high strength flexible web or material 94. The web 94 can be formed of a carbon fiber mesh that is embedded in a thin water impermeable polymer sheet. The supports 92 and web 94 can be secured to a base 96. An activation or control mechanism 98 can close the funnel 90 by positioning the supports 92 inwardly towards each other as shown in FIG. 23, or move the supports at an angle, for example 90°, outwardly to open the funnel 90. In one embodiment, the web 94 can be fastened to a helix, for example, formed of slippery material such as PTFE, that is wound like a snake in the geometry of a tube.

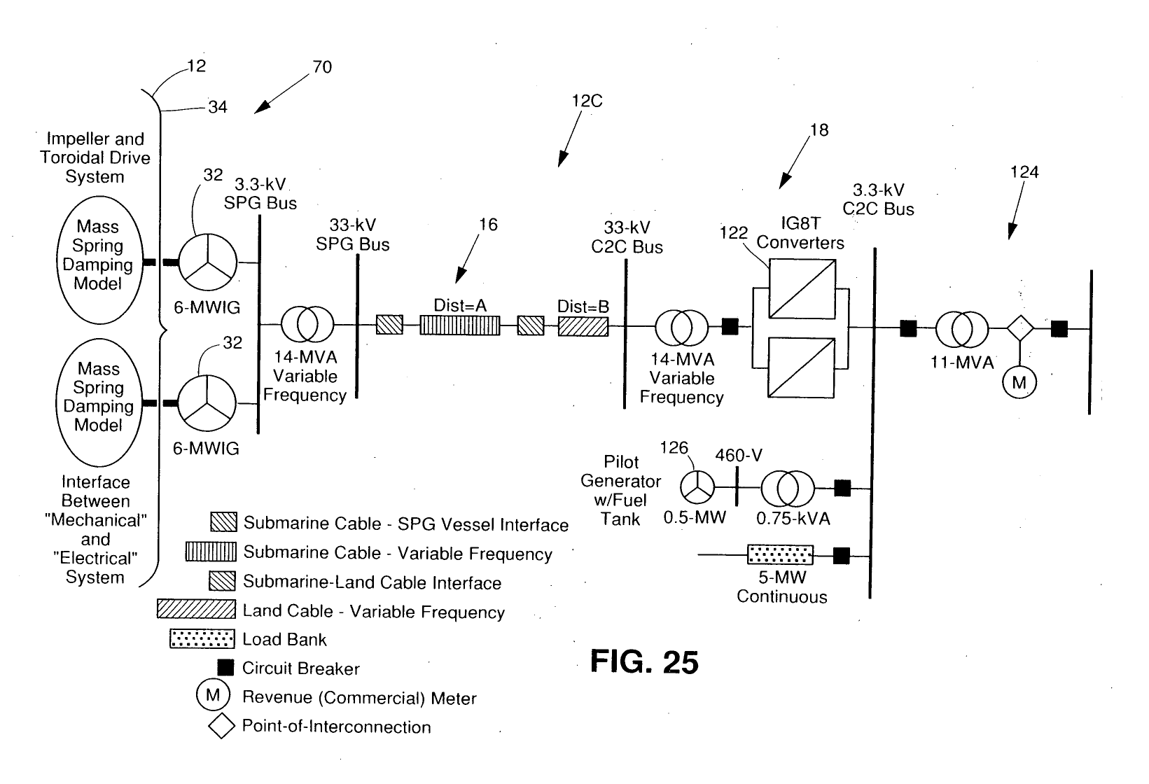

Referring to FIG. 25, power generation system 120 can convert water current 9 into electricity by a turbine apparatus 70 having turbines 12, transmissions 34 and generators 32. Variable frequency electric power can be conveyed by cable 16 to station 18 which is converted by converters 122 into power or a form for delivery to customers 124. Station 18 can include an engine powered generator 126 which can provide supplemental electric power during times of high demand, or during times of reduced water currents 9, for example, changing tides.

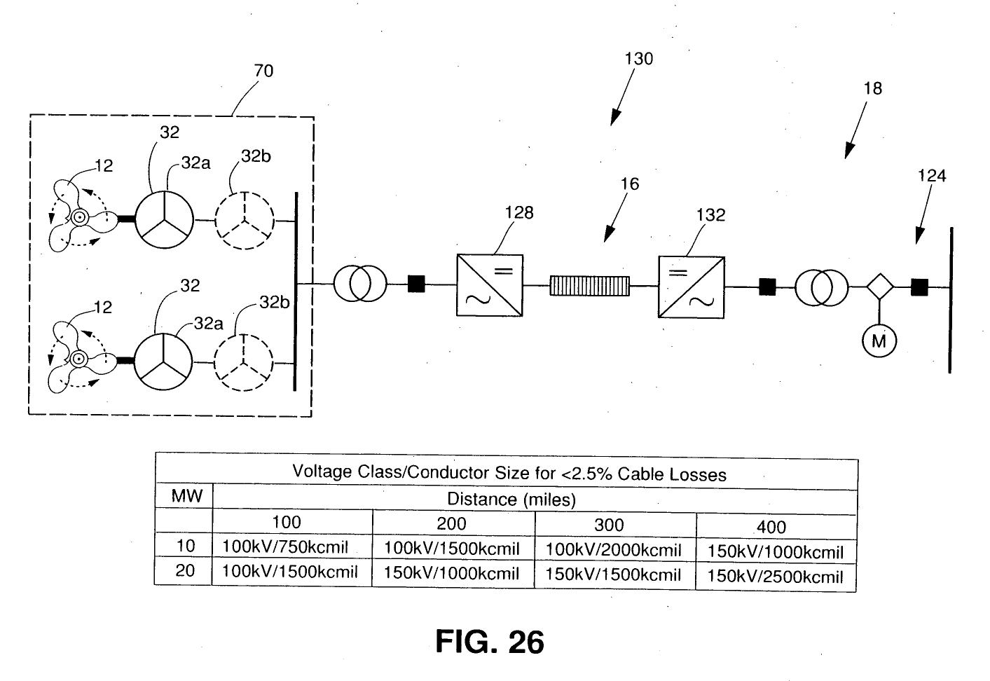

Referring to FIG. 26, power generation system 130 can have a turbine apparatus 70 with generators 32 optionally having generating units 32a and 32b. The electric power can be converted by converter 128 into a form suitable for long distance transmission in cable 16, for example, distances of 100 to 400 km, and then converted by converter 132 into a form suitable for delivery to customers 124. The electric power can be converted between AC and DC power. Although FIGS. 25 and 26 depict one turbine apparatus 70, it is understood that multiple turbine apparatuses can be employed, and can be of various embodiments.

Referring to FIG. 27, data acquisition, sensing and control system 140 can include sensors 142 associated with the turbine apparatus 70 for sensing conditions within and surrounding apparatus 70, including, position, orientation, altitude, pitch, yaw, roll, depth, rotational speeds of rotating components, such as turbine 12, transmission 34 and generator 32, etc., torque, pressure, stress or force, voltage and electrical current output, frequency, electrical load on components, temperature of components such as bearings, generator, conductors, housing, transmission, etc., water current flow speed and direction, acoustic noise frequency patterns or resonances, sonar signals (friend or foe), etc. Signals from the sensors 142 can be converted by a fiber optic interface 146 for transmission through fiber optics in cable 16, which can be converted back by another fiber optic interface 146. Depending upon the conditions sensed by sensors 142, protection or control system 148 can send signals back through cable 16 to control devices 143 for controlling the turbine apparatus 70. The control devices 143 can include control circuits, switches, motors, valves, actuators, pumps, etc. for controlling components and operation of the turbine apparatus 70. For example, aspects of the positioning of the turbine apparatus 70, or the operation of the clutch 35, generator 32, or the electric power generated can be controlled. For example, sensors 142 can sense changes in the water current 9, and control system 148 can move the turbine apparatus 70 into the optimum position, orientation and depth. The system 140 can be controlled by a controller 150 and a remote terminal 144 can be positioned within turbine apparatus 70 for controlling on site. It is understood that control system 140 can be used with various embodiments of turbine apparatuses.

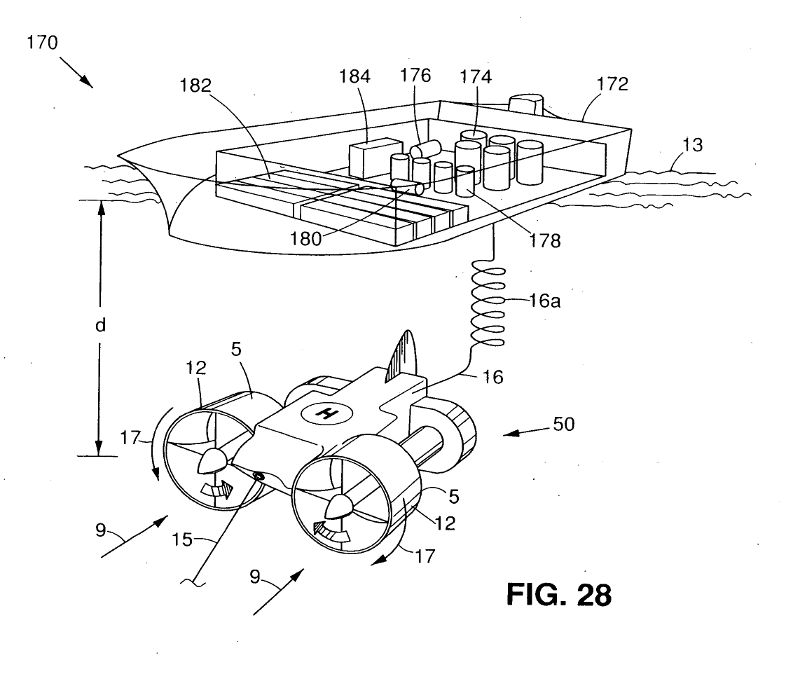

Referring to FIG. 28, desalinization system 170 can include a turbine apparatus 50 positioned at a depth d below the water surface 13. Turbine apparatus 50 is shown for illustrative purposes and it is understood that other turbine apparatuses such as apparatus 70 can be included in desalinization system 170. Electricity generated by turbine apparatus 50 is supplied to desalinization plant 172 by cable 16. The desalinization plant 172 can be within a floating platform, such as a boat or ship, or can be land based. The desalinization plant 172 can include 5 micron filters 174, a feed pump 176, 3 micron filters 178, a high pressure pump 180 and membrane skids 182. The process can be controlled by a control panel 184. The turbine apparatus 50 can have two turbine units 5 which can each generate 5 mW. Desalinization system 170 can be sized to produce 60 million m³ of fresh water daily.

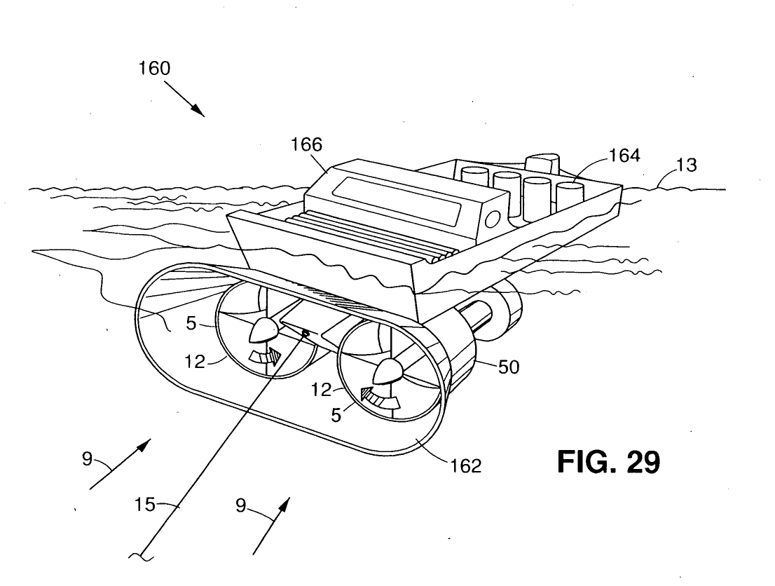

Referring to FIG. 29, desalization system 160 differs from desalinization system 170 in that turbine apparatus 50 is mounted to the bottom of a desalinization plant 164 that floats on the water surface 13. As a result, the turbine apparatus 50 is positioned just below the water surface 13. The turbine apparatus 50 can have a funnel 162 for directing water current 9 into the turbines 12, and increasing the water speed. The turbine apparatus 50 can be secured by one or more mooring lines 15. The desalization plant 160 can have a control room 166, and can be suitable for use in tidal currents. It is understood that various turbine apparatuses can be employed.

While this invention has been particularly shown and described with references to example embodiments thereof, it will be understood by those skilled in the art that various changes in form and details may be made therein without departing from the scope of the invention encompassed by the appended claims.

It is understood that various features of the embodiments shown and described can be combined or omitted. Although particular dimensions, sizes and capacities have been described, it is understood that dimensions, sizes and capacities can vary depending upon the application at hand. In addition, the turbine apparatuses shown and described can be mounted on land or in the air for being wind powered.

What is claimed is:

1. A submersible turbine apparatus comprising:
first and second buoyant turbine units connected to each other side by side, laterally apart from each other, each turbine unit comprising turbine blades rotatably mounted about an elongate stationary axle; and
a lower elongate sealed chamber centrally connected to the first and second turbine units below the stationary axles in a manner to provide a center of gravity centrally positioned below the laterally spaced buoyant first and second turbine units to stabilize the turbine apparatus when submersed.

2. The turbine apparatus of claim 1 in which the first and second turbine units each comprise turbine blades rotatably mounted about the stationary axle by a bearing arrangement, the turbine blades being rotatably coupled to an electric generator by a transmission, the electric generator and the transmission being positioned within a sealed hollow cavity of the stationary axle.

3. The turbine apparatus of claim 2 further comprising a clutch between the transmission and electric generator for controlling the rotational speed of the electric generator.

4. The turbine apparatus of claim 2 in which the transmission has a ratio of at least about 320:1.

5. The turbine apparatus of claim 4 in which the transmission comprises a torroidal drive transmission with a ratio of about 625:1.

6. The turbine apparatus of claim 4 in which the electric generator is rotated at a speed of at least about 2000 rpm.

7. The turbine apparatus of claim 2 in which the first and second turbine units, and the lower chamber are connected together by frame members.

8. The turbine apparatus of claim 2 in which the lower chamber includes upstream and downstream ballast control.

9. The turbine apparatus of claim 8 further comprising a controllable mooring system for controllably positioning the turbine apparatus when submersed.

10. The turbine apparatus of claim 9 further comprising a cable extending from the turbine apparatus for conveying electricity generated by the electric generator to a desired location, the cable having a portion that is arranged in a spiral configuration to allow movement of the turbine apparatus.

11. The turbine apparatus of claim 10 further comprising a sensor system for sensing conditions within and surrounding the turbine apparatus.

12. The turbine apparatus of claim 11 further comprising a control system for controlling operation of the turbine apparatus based on the sensed conditions.

13. The turbine apparatus of claim 2 in which the bearing arrangement comprises:
a radial bearing arrangement comprising magnetic repulsion bearings; and
a thrust bearing arrangement for absorbing thrust exerted on the turbine blades, the thrust bearing arrangement comprising a series of axially sequential thrust bearing surfaces for distributing thrust axially sequentially, the thrust bearing surfaces being in magnetic repulsion.

14. The turbine apparatus of claim 13 in which the thrust bearings surfaces are covered with a wear resistant covering.

15. The turbine apparatus of claim 14 in which the wear resistant covering is diamond.

16. The turbine apparatus of claim 15 in which the wear resistant covering is silicon nitride.

17. The turbine apparatus of claim 2 in which the hollow cavity of the stationary axle is about 3 m in diameter and includes an access hatch to allow a person to enter and walk inside the stationary axle.

18. The turbine apparatus of claim 2 in which the turbine blades have a light weight shell covering a porous interior structure.

19. The turbine apparatus of claim 18 in which each turbine unit has four turbine blades slanted at about a 14° angle.

20. The turbine apparatus of claim 18 in which the turbine blades are configured for bi-directional use.

21. The turbine apparatus of claim 18 in which the turbine blades have a diameter in the range of about 30 m to 50 m.

22. The turbine apparatus of claim 18 in which the turbine blades are buoyant.

23. The turbine apparatus of claim 2 further comprising a desalinization device electrically connected to the electric generator.

24. A submersible turbine apparatus comprising:
a stationary axle;
turbine blades rotatably mounted about the stationary axle by a radial bearing arrangement; and
a thrust bearing arrangement for absorbing thrust exerted on the turbine blades, the thrust bearing arrangement comprising a series of axially sequential thrust bearing surfaces for distributing thrust axially sequentially.

25. The turbine apparatus of claim 24 in which the radial bearing arrangement comprises magnetic repulsion bearings.

26. The turbine apparatus of claim 25 in which the turbine blades are buoyant, thereby reducing the load on the magnetic repulsion bearings of the radial bearing arrangement.

27. The turbine apparatus of claim 24 in which the thrust bearing arrangement comprises at least three opposed pairs of thrust bearing surfaces.

28. The turbine apparatus of claim 24 in which the thrust bearing surfaces are covered with a wear resistant covering.

29. The turbine apparatus of claim 24 in which the thrust bearing surfaces are in magnetic repulsion.

30. The turbine apparatus of claim 24 further comprising:
an electric generator powered by the turbine blades; and
a desalinization device electrically connected to the electric generator.

31. A submersible turbine apparatus comprising:
an elongate stationary axle having a sealed hollow cavity;
turbine blades rotatable mounted about the stationary axle by a bearing arrangement and rotatably coupled to an electric generator by a transmission, the electric generator and the transmission being positioned within the sealed hollow cavity of the stationary axle, the transmission having a ratio of at least about 320:1 for increasing rotational speed to the electric generator.

32. The turbine apparatus of claim 31 further comprising a clutch coupled between the transmission and the electric generator for controlling the rotational speed of the electric generator.

33. The turbine apparatus of claim 32 in which the transmission is a torroidal drive transmission.

34. The turbine apparatus of claim 33 in which the transmission has a ratio of at least about 400:1.

35. The turbine apparatus of claim 34 in which the transmission has a ratio of at least about 500:1.

36. The turbine apparatus at claim 35 in which the transmission has a ratio of at least about 600:1.

37. The turbine apparatus of claim 36 in which the transmission has a ratio of about 625:1.

38. The turbine apparatus of claim 36 in which the electric generator is rotated at a speed of at least about 2000 rpm.

39. The turbine apparatus of claim 31 further comprising a desalination device electrically connected to the electric generator.

40. A submersible turbine apparatus comprising:
a stationary axle; and
a buoyant turbine rotatably mounted about the stationary axle, the turbine having a central hub, a series of turbine blades extending from the hub to a cylindrical outer rim, the turbine blades having a light weight shell covering a porous interior structure.

41. A method of operating a turbine apparatus comprising:
submersing the turbine apparatus in a water current, the turbine apparatus having first and second buoyant turbine units for being driven by the water current;
connecting the first and second turbine units to each other side by side, laterally apart from each other, each turbine unit comprising turbine blades rotatably mounted about an elongate stationary axle; and
connecting a lower elongate sealed chamber to the first and second turbine units centrally below the stationary axles in a manner to provide a center of gravity centrally positioned below the laterally spaced buoyant first and second turbine units to stabilize the turbine apparatus when submersed.

42. The method of claim 41 in which the first and second turbine units each comprise turbine blades rotatably mounted about the stationary axle by a bearing arrangement, the method further comprising rotatably coupling the turbine blades of each turbine unit to an electric generator by a transmission, the electric generator and the transmission being positioned within a sealed hollow cavity of the stationary axle.

43. The method of claim 42 further comprising controlling the rotational speed of the electric generator with a clutch between the transmission and electric generator.

44. The method of claim 42, further comprising rotating the electric generator with the transmission, the transmission having a ratio of at least about 320:1.

45. The method of claim 44 further comprising rotating the electric generator with a torroidal drive transmission having a ratio of about 625:1.

46. The method of claim 44 further comprising rotating the electric generator at a speed of at least about 2000 rpm.

47. The method of claim 42 further comprising connecting the first and second turbine units, and the lower chamber together by frame members.

48. The method of claim 42 further comprising providing the lower chamber with upstream and downstream ballast control.

49. The method of claim 48 further comprising controllably positioning the turbine apparatus with a controllable mooring system.

50. The method of claim 44 further comprising extending a cable from the turbine apparatus for conveying electricity generated by the electric generator to a desired location, the cable having a portion that is arranged in a spiral configuration to allow movement of the turbine apparatus.

51. The method of claim 50 further comprising sensing conditions within and surrounding the turbine apparatus with a sensor system.

52. The method of claim 51, further comprising controlling operation of the turbine apparatus with a control system based on the sensed conditions.

53. The method of claim 42 further comprising supporting the turbine blades of each turbine unit with a radial bearing arrangement comprising magnetic repulsion bearings, and a thrust bearing arrangement for absorbing thrust exerted on the turbine blades, the thrust bearing arrangement comprising a series of axially sequential thrust bearing surfaces for distributing thrust axially sequentially, the thrust bearing surfaces being in magnetic repulsion.

54. The method of claim 53 further comprising covering the thrust bearing surfaces with a wear resistant covering.

55. The method of claim 54 further comprising covering the thrust bearing surfaces with diamond.

56. The method of claim 55 further comprising covering the thrust bearing surfaces with silicon nitride.

57. The method of claim 42 further comprising providing the hollow cavity of the stationary axle with a diameter of about 3 m and including an access hatch to allow a person to enter and walk inside the stationary axle.

58. The method of claim 42 further comprising providing the turbine blades with a light weight shell covering a porous interior structure.

59. The method of claim 58 further comprising providing each turbine unit with four turbines blades slanted at about a 14° angle.

60. The method of claim 58 further comprising configuring the turbine blades for bi-directional use.

61. The method of claim 58 further comprising providing the turbine blades with a diameter in the range of about 30 m to 50 m.

62. The method of claim 58 further comprising providing buoyant turbine blades.

63. The method of claim 42 further comprising electrically connecting a desalinization device to the electric generator.

64. A method of operating a turbine apparatus comprising:
rotatably mounting turbine blades of the turbine apparatus about a stationary axle with a radial bearing arrangement;
submersing the turbine apparatus in a water current; and
absorbing thrust exerted on the turbine blades with a thrust bearing arrangement, the thrust bearing arrangement comprising a series of axially sequential thrust bearing surfaces for distributing thrust axially sequentially.

65. The method of claim 64 further comprising providing the radial bearing arrangement with magnetic repulsion bearings.

66. The method of claim 65 further comprising reducing the load on the magnetic repulsion bearings of the radial bearing arrangement with turbine blades that are buoyant.

67. The method of claim 64 further comprising absorbing thrust with the thrust bearing arrangement comprising at least three opposed pairs of thrust bearing surfaces.

68. The method of claim 64 further comprising covering the thrust bearing surfaces with a wear resistant covering.

69. The method of claim 64 further comprising providing the thrust bearing surfaces with magnetic repulsion.

70. The method of claim 64 further comprising:
powering an electric generator with the turbine blades; and
electrically connecting a desalinization device to the electric generator.

71. A method of operating a turbine apparatus comprising:
rotatably mounting turbine blades about an elongate stationary axle by a bearing arrangement, the stationary axle having a sealed hollow cavity;
rotatably coupling the turbine blades to an electric generator with a transmission, the electric generator and the transmission being positioned within the sealed hollow cavity of the stationary axle, the transmission having a ratio of at least about 320:1 for increasing rotational speed to the electric generator; and
submersing the turbine apparatus in a water current.

72. The method of claim 71 further comprising controlling the rotational speed of the electric generator with a clutch coupled between the transmission and the electric generator.

73. The method of claim 72 further comprises employing a torroidal drive transmission.

74. The method of claim 73 further comprising providing the transmission with a ratio of at least about 400:1.

75. The method of claim 74 further comprising providing the transmission with a ratio of at least about 500:1.

76. The method of claim 75 further comprising providing the transmission with a ratio of at least about 600:1.

77. The method of claim 76 further comprising providing the transmission with a ratio of about 625:1.

78. The method of claim 76 further comprising rotating the electric generator at a speed of at least about 2000 rpm.

79. The method of claim 71 further comprising electrically connecting a desalinization device to the electric generator.

80. A method of operating a turbine apparatus comprising:
rotatably mounting a buoyant turbine about a stationary axle, the turbine having a central hub, a series of turbine blades extending from the hub to a cylindrical outer rim, the turbine blades having a light weight shell covering a porous interior structure; and
submersing the turbine apparatus in a water current.
